(19) United States
(12) Patent Application Publication
(10) Pub. No.: US 2025/0166339 A1
(43) Pub. Date: May 22, 2025

(54) SEMI-SUPERVISED AND ROBUST MULTISPECTRAL VIDEO SEMANTIC SEGMENTATION SYSTEM

(71) Applicant: SAMSUNG ELECTRONICS CO., LTD., Suwon-si (KR)

(72) Inventors: Wenbo LI, Santa Clara, CA (US); Yilin SHEN, Mountain View, CA (US); Hongxia JIN, San Jose, CA (US)

(73) Assignee: SAMSUNG ELECTRONICS CO., LTD., Suwon-si (KR)

(21) Appl. No.: 18/955,003

(22) Filed: Nov. 21, 2024

Related U.S. Application Data
(60) Provisional application No. 63/601,900, filed on Nov. 22, 2023.

(51) Int. Cl. G06V 10/26; G06V 10/30; G06V 10/58; G06V 10/82

(52) U.S. Cl. CPC G06V 10/26; G06V 10/30; G06V 10/58; G06V 10/82

(57) ABSTRACT

A method includes generating a pair of features of a current frame by inputting the current frame into a first cross-collaborative consistency learning (C3L) model, the current frame comprising a red-green-blue (RGB) image and a thermal image; generating a pair of denoised features by inputting the of pair of features of the current frame and one or more pairs of features of past frames into a denoised memory read (DMR) model; generating an updated pair of denoised features by inputting the pair of denoised features into a second C3L model, the updated pair of denoised features comprising an updated RGB image feature and an updated thermal feature; and generating a segmentation mask by inputting the updated pair of features into a segmentation head.

### CROSS-REFERENCE TO RELATED APPLICATION

This application claims priority to U.S. provisional application No. 63/601,900 filed on Nov. 22, 2023, the entire contents of which are incorporated herein by reference.

### BACKGROUND

### 1. Field

This disclosure is directed to a robust semantic segmentation in multispectral videos.

### 2. Related Art

Semantic segmentation is the process of categorizing each pixel in an image/video to a specific class label, playing a vital role in understanding the content of scenes and locating target objects. Semantic segmentation has many potential applications such as autonomous driving, robotics, and augmented reality.

Over the past decades, the evolution of this domain has been remarkable, particularly in RGB-image based semantic segmentation. As the accessibility to thermal sensors rises, multispectral semantic segmentation (MSS) has attracted great interest. Paired thermal imagery records thermal radiation from objects with temperatures above absolute zero, thereby making it invaluable for comprehending challenging scenes in unfavorable situations, such as low-light, nighttime, and overexposure. On a parallel trajectory, the dynamic and ever-changing nature of real-world scenarios has propelled enthusiasm in video semantic segmentation (VSS). In contrast to its static counterparts, dynamic videos encapsulate motion variations, blurs, large object deformations, and the need for temporal consistency. By harnessing temporal contexts within video sequences (VSS), methods have showcased enhanced segmentation accuracy in dynamic environments.

### SUMMARY

According to an aspect of the disclosure, a method performed by at least one processor, includes generating a pair of features of a current frame by inputting the current frame into a first cross-collaborative consistency learning (C3L) model, the current frame comprising a red-green-blue (RGB) image and a thermal image; generating a pair of denoised features by inputting the of pair of features of the current frame and one or more pairs of features of past frames into a denoised memory read (DMR) model; generating an updated pair of denoised features by inputting the pair of denoised features into a second C3L model, the updated pair of denoised features comprising an updated RGB image feature and an updated thermal feature; and generating a segmentation mask by inputting the updated pair of features into a segmentation head.

According to an aspect of the disclosure, an apparatus including: a memory storing one or more instructions; and a processor operatively coupled to the memory and configured to execute the one or more instructions stored in the memory, wherein the one or more instructions, when executed by the processor, cause the apparatus to: generate a pair of features of a current frame by inputting the current frame into a first cross-collaborative consistency learning (C3L) model, the current frame comprising a red-green-blue (RGB) image and a thermal image, generate a pair of denoised features by inputting the of pair of features of the current frame and one or more pairs of features of past frames into a denoised memory read (DMR) model, generate an updated pair of denoised features by inputting the pair of denoised features into a second C3L model, the updated pair of denoised features comprising an updated RGB image feature and an updated thermal feature, and generate a segmentation mask by inputting the updated pair of features into a segmentation head.

According to an aspect of the disclosure, a non-transitory computer readable medium having instructions stored therein, which when executed by a processor cause the processor to perform a method including: generating a pair of features of a current frame by inputting the current frame into a first cross-collaborative consistency learning (C3L) model, the current frame comprising a red-green-blue (RGB) image and a thermal image; generating a pair of denoised features by inputting the of pair of features of the current frame and one or more pairs of features of past frames into a denoised memory read (DMR) model; generating an updated pair of denoised features by inputting the pair of denoised features into a second C3L model, the updated pair of denoised features comprising an updated RGB image feature and an updated thermal feature; and generating a segmentation mask by inputting the updated pair of features into a segmentation head.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3 illustrates example images, in accordance with embodiments of the present disclosure.

FIG. 4 illustrates example training images, in accordance with embodiments of the present disclosure.

FIG. 5 illustrates an example semi-supervised multispectral video semantic segmentation system, in accordance with embodiments of the present disclosure.

FIG. 6 illustrates an example Cross-Collaborative Consistency Learning (C3L) model, in accordance with embodiments of the present disclosure.

FIG. 7 illustrates an example Dual C3L model, in accordance with embodiments of the present disclosure.

FIG. 8 illustrates a flow chart of an example process for a segmentation process, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to a semi-supervised multispectral video semantic segmentation system that includes a Cross-Collaborative Consistency Learning (C3L) model that leverages consistency between visual and thermal modalities, a Denoised Memory Read (DMR) module that uses context-rich unlabeled past memory frames, and a Dual-C3L model that regularizes memory-augmented features.

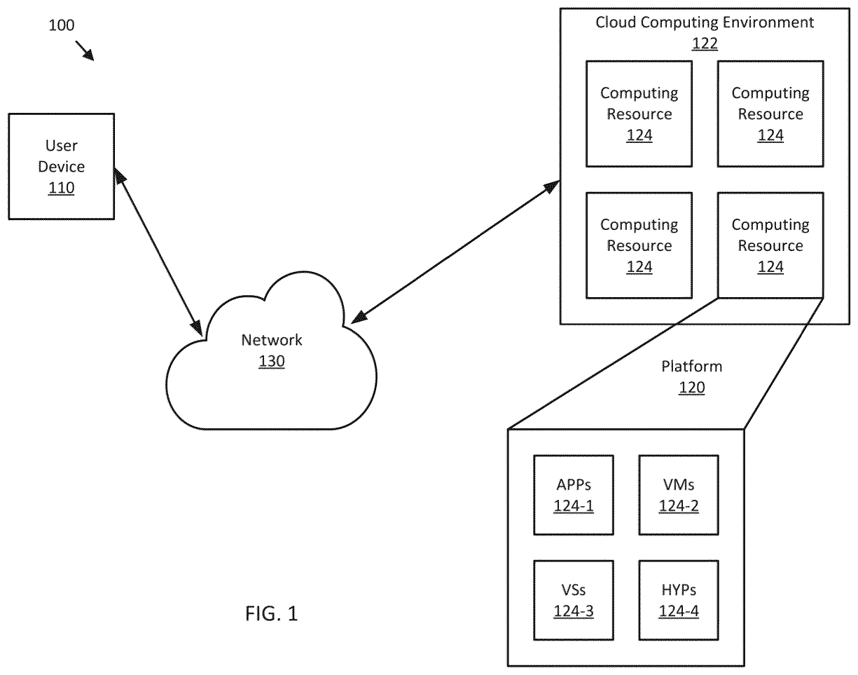

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (e.g., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

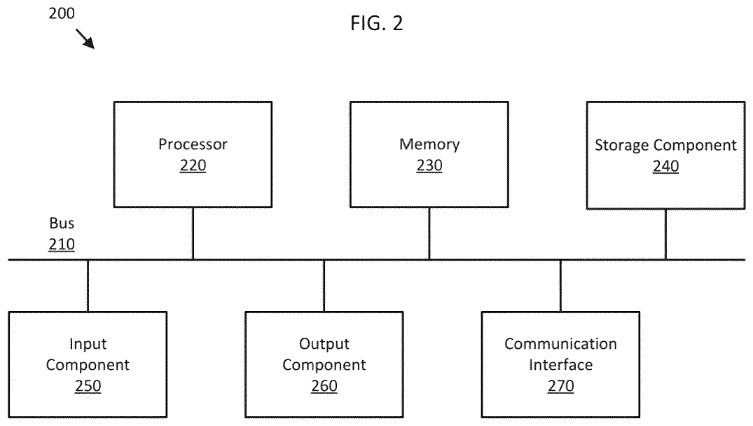

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more examples, the device 200 may be a controller of a smart home system that communicates with one or more sensors, cameras, smart home appliances, and/or autonomous robots. The device 200 may communicate with the cloud computing environment 122 to offload one or more tasks.

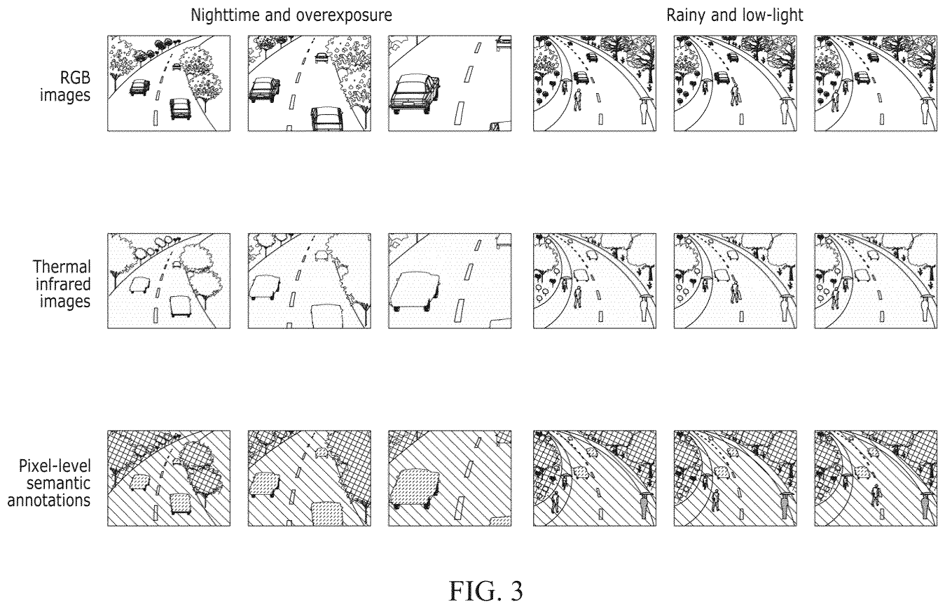

Robust and reliable semantic segmentation in complex scenes is crucial for many real-life applications such as home robots and autonomous driving. Most approaches typically make use of RGB images as input. However, these approaches work well only in preferred lighting conditions. When facing adverse lighting conditions, such as overexposure or low-light (see FIG. 3 illustrating example RGB images, thermal infrared images, and pixel-level semantic annotation images), these approaches often fail to deliver satisfactory results.

These failures have led to the recent investigation into multispectral semantic segmentation, where RGB and thermal infrared (RGBT) images are both utilized as input. This gives rise to significantly more robust segmentation of image objects in complex scenes and under adverse conditions. Nevertheless, the present focus in single RGBT image input restricts existing methods from addressing dynamic real-world scenes. As a result, multispectral video semantic segmentation is needed.

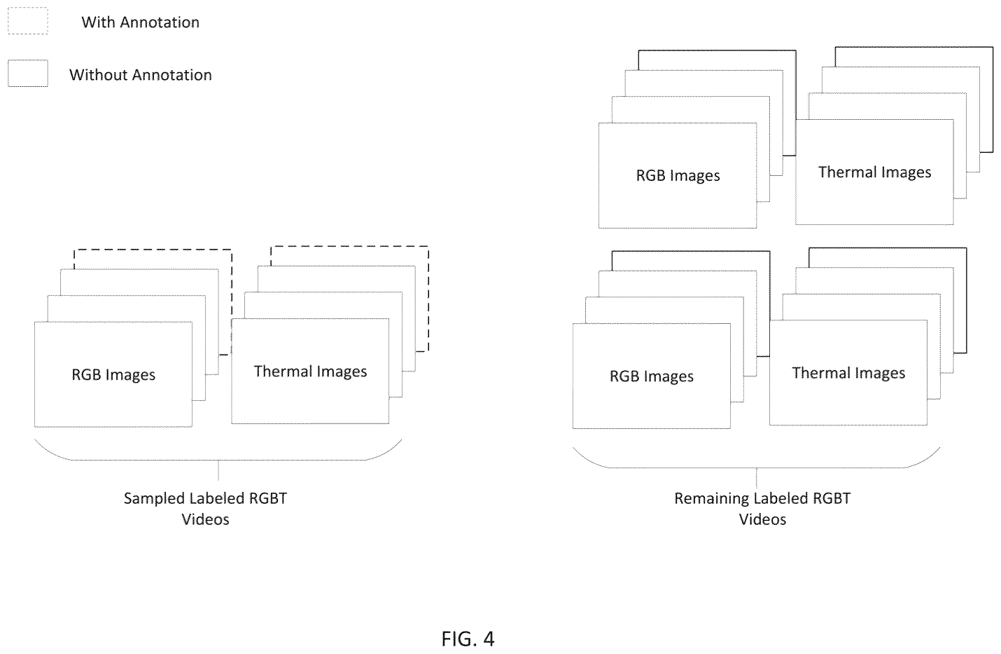

To overcome these challenges, the embodiments of the present disclosure are directed to semi-supervised MVSS framework named SemiMV to resolve the issues associated with segmentation requiring label-hungry data. As depicted in FIG. 4, in one or more examples, SemiMV utilizes a small set of labeled multispectral videos complemented by a larger set of unlabeled counterparts. The labeled set may be sparsely annotated due to the prohibitive costs of detailed semantic labeling and similar contents shared in consecutive video frames. In one or more examples, an extensive pool of unlabeled data includes both entirely unlabeled multispectral videos and context-rich unlabeled intra-video frames. The embodiments of the present disclosure include a C3L model and a DMR model. The C3L model and a DMR model may be machine learning models including one or more neural networks. The C3L model introduces a novel strategy for cross-collaborative pseudo training across different modalities. This model not only fosters learning of cross-modality consistency, but also supports mutual error correction, enhancing the robustness of the model using unlabeled RGB-Thermal pairs. In one or more examples, the DMR model is configured to selectively extract contextual information from a “denoised” memory bank, aiming to enhance the model's capability to generate more precise and noise-resistant segmentation outputs.

Pixel-wise semantic labeling in MVSS grapples with extremely high costs and labor intensity, particularly due to the large volume of video frames and the complexity of low-light scenes, leading to difficulties in obtaining large-scale multispectral video annotations.

In the existing multispectral video semantic segmentation dataset (e.g., MVSeg), there are 93% unlabeled image pairs. This means that if fully-supervised training is performed for the multispectral video semantic segmentation, only 7% of the training data may be used, where the remaining 93% unlabeled data is discarded. Therefore, there is a need the semi-supervised multispectral video semantic segmentation in order to utilize all training data including both the limited labeled data and a large amount of the unlabeled data.

As shown in FIG. 4, a modest quantity of labeled multispectral videos with sparse annotations and a larger corpus of completely unlabeled multispectral videos may be used. Each video clip may contain a sequence of t frame pairs, with only the final pair in labeled clips having annotations. We denote a multispectral video clip as V={(Iᵢ^{R}, Iᵢ^{T})}ᵢ₌₁^{t}, where each frame pair (Iᵢ^{R}, Iᵢ^{T}) may have a spatial resolution of H×W. The labeled set, D^{L}={(V^{L}ₙ, yₙ)}ₙ₌₁ⁿ^{_{L}}, comprises n_{L} video clips with pixel-level ground-truth labels yₙ for the final frame pair of each clip, in a space of C classes. The unlabeled set, D^{U}={Vₙ^{U}}ₙ₌₁ⁿ^{_{U}} includes n_{U} unlabeled multispectral video clips. Additionally, a separate set of labeled video clips, D^{V}={(Vₙ^{V}, yₙ)}ₙ₌₁ⁿ^{_{V}}, may be used for performance evaluation. The embodiments of the present disclosure provide a semantic segmentation model that can effectively learn from D^{L} and D^{U}, and exhibit robust generalization to D^{V}.

According to one or more embodiments, the C3L model leverages the inherent consistency between visual and thermal modalities as a guiding force to effectively utilize unlabeled RGB-Thermal frame pairs. In one or more examples, the C3L model produces the pseudo semantic labels for the unlabeled training data, and the pseudo labels for the visual (RGB) features and thermal features come from the opposition side. The pseudo labels may be used to supervise a model's output deriving from the unlabeled input.

According to one or more embodiments, the DMR model makes use of the context-rich unlabeled intra-video past memory frames to augment the features of the current frame by selectively extracting denoised contextual cues from memory frames.

According to one or more embodiments, the Dual-C3L model makes full use of the unlabeled data and to further regularize the memory-augmented features via the C3L loss.

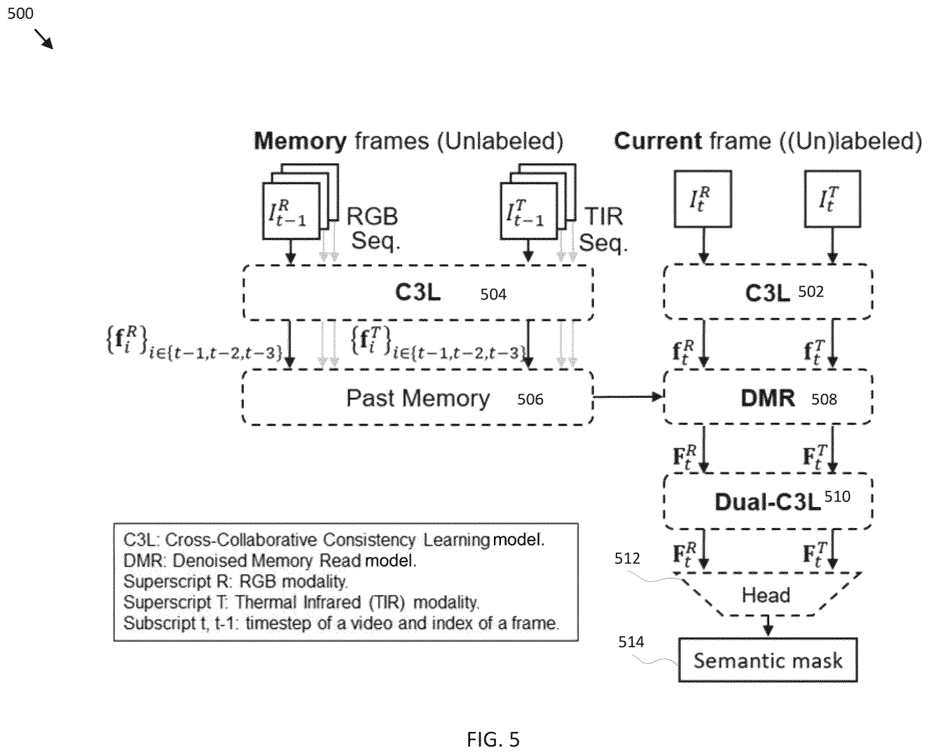

FIG. 5 illustrates an example semi-supervised MVSS system 500, according to one or more embodiments. The system 500 may take, as input, a multispectral video clip, which contains a query pair of RGB and thermal frames at time step t, and M Memory pairs from past frames. In one or more examples, only Query pairs from the labeled video set may be accompanied with ground-truth annotations. The RGB-Thermal frame pairs may be fed into two parallel segmentation networks (DeepLabv3+), to generate initial segmentation maps Pᵢ^{R} and Pᵢ^{T}, where i∈{t−M, . . . , t}.

In one or more examples, the RGB-Thermal pair of the current frame (unlabeled or labeled) are fed into a C3L model 502 to obtain feature pairs {fₜ^{R}, fₜ^{T}}, and the RGB-Thermal pair (unlabeled) are fed into C3L model 504 to obtain feature pairs {fᵢ^{R}, fᵢ^{T}}_{i∈{t-1, t-2, t-3}}. In C3L model 502 and C3L model 504, cross pseudo supervisions are received to enforce consistency between two modalities. The feature pairs {fᵢ^{R}, fᵢ^{T}}_{i∈{t-1, t-2, t-3}} are processed in past memory 506 to become the denoised past memory. Then, the feature pairs of the current frame {fₜ^{R}, fₜ^{T}} are fed into DMR model 508 in which {fₜ^{R}, fₜ^{T}} is enhanced by the denoised past memory and becomes {Fₜ^{R}, Fₜ^{T}}. In one or more examples, the enhancement of a feature pair may correspond to a denoising of the feature pair. Next, the enhanced feature pair {Fₜ^{R}, Fₜ^{T}}, which is also referred to as denoised feature pair, is fed to Dual-C3L 510 to further receive the cross pseudo supervisions to enforce consistency between two modalities. Finally, the feature pair {Fₜ^{R}, Fₜ^{T}} output from is fed into the segmentation head 512 to obtain the semantic segmentation mask 514.

The C3L model harnesses the capabilities of un-labeled RGB-Thermal frame pairs. A notable characteristic of RGB-Thermal pairs is their ability to capture the same scene from two distinct perspectives: visible light and thermal infrared. This unique dual-perspective trait provides inherent consistency between visual and thermal modalities that act as a guide to effectively utilize unlabeled RGB-Thermal frame pairs.

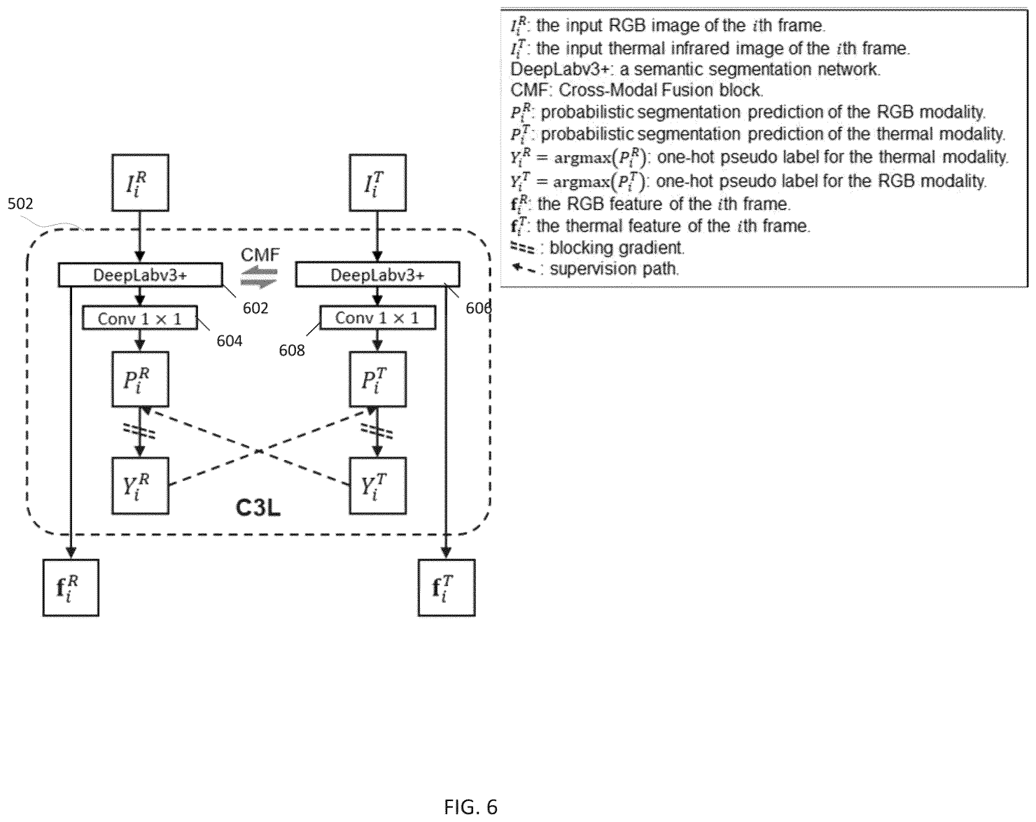

FIG. 6 illustrates the flow of C3L model 502. The structure of C3L model 502 in FIG. 6 may also apply to the C3L model 504 in FIG. 5. First, the RGB-Thermal pair {Iᵢ^{R}, Iᵢ^{T}} of the ith frame is fed into DeepLabv3+(602, 606) to obtain the feature pair {fᵢ^{R}, fᵢ^{T}}. In DeepLabv3+, the intermediate features may go through a common metadata framework (CMF) to get augmented. Then, the feature pair {fᵢ^{R}, fᵢ^{T}} is fed into a Cony 1×1 layer (604, 608) to obtain the probabilistic segmentation prediction {Pᵢ^{R}, Pᵢ^{T}} of each modality. Next, a pair of one-hot pseudo labels {Yᵢ^{R}, Yᵢ^{T}} may be computed by hardening the probabilistic segmentation predictions {Pᵢ^{R}, Pᵢ^{T}}. In one or more examples, the cross-modality consistency is attained through cross pseudo supervisions as:

$${ℒ}_{c 3 l} = {𝔼}_{( {I}_{i}^{R} , {I}_{i}^{T} ) ∈ {D}^{U} ⋃ {D}^{L}} ( {l}_{c e} ( {P}_{i}^{R} , {Y}_{i}^{T} ) + {l}_{c e} ( {P}_{i}^{T} , {Y}_{i}^{R} ) ) \qquad Eq . ( 1 )$$

In one or more examples, for labeled query images, supervised training may be employed on the outputs of the two networks using ground-truth segmentation maps, represented by:

$${ℒ}_{sup} = {𝔼}_{( {I}_{t}^{R} , {I}_{t}^{T} , y ) ∈ {𝒟}^{L}} ( {l}_{ce} ( {P}_{t}^{R} , y ) + {l}_{ce} ( {P}_{t}^{T} , y ) ) , \qquad Eq . ( 2 )$$

where (Iᵢ^{R}, Iᵢ^{T}, y) ∈ D^{L} represents all query pairs and their corresponding ground-truth maps y from the labeled set D^{L}, and I_{ce} denotes the cross-entropy loss function.

In one or more examples, the pair of one-hot pseudo labels may be computed by hardening the probabilistic segmentation predictions of both modalities, using an argmax function:

$${Y}_{i}^{R} , {Y}_{i}^{T} = arg max ( {P}_{i}^{R} ) , arg max ( {P}_{i}^{T} ) \qquad Eq . ( 3 )$$

Following this, the cross-modality consistency may be attained through [symbol] _{c3l}, as computed above.

In one or more examples, DeepLab is a family of semantic segmentation models having the ability to capture fine-grained details and perform semantic segmentation on high-resolution images. DeepLabv2 is an architecture for semantic segmentation that builds on DeepLab with an atrous spatial pyramid pooling scheme. DeepLabv2 may use parallel dilated convolutions with different rates applied in the input feature map, which are then fused together. DeepLabv3 is a semantic segmentation architecture that improves upon DeepLabv2 with several modifications. To handle the problem of segmenting objects at multiple scales, modules are designed which employ atrous convolution in cascade or in parallel to capture multi-scale context by adopting multiple atrous rates. DeepLabv3+ is another semantic segmentation architecture that builds on DeepLabv3 by adding a decoder module to enhance segmentation results.

According to one or more embodiments, to utilize the context-rich unlabeled intra-video past frames, the DMR model 508 (FIG. 5) to augments the features of the current frame {fₜ^{R}, fₜ^{T}} by selectively extracting denoised contextual cues from the features of the memory frames {fᵢ^{R}, fᵢ^{T}}_{i∈{t-1, t-2, t-3}}. The memory features may each have a dimension of H×W×D, where D is the channel number. Due to the absence of ground-truth supervisions for past frames, memory features {fᵢ^{R}, fᵢ^{T}}_{i∈{t-1, t-2, t-3}} may be prone to unreliability. To deal with this issue, a reliability estimation strategy may be used. In this regard, reliable RGB and thermal features tend to yield more consistent predictions. Conversely, discrepancies in these predictions can, to a certain extent, suggest potential unreliability. To quantify these features, a normalized bidirectional KL divergence function is formulated to estimate a pixel-wise reliability map [symbol] ᵢ as:

$${ℛ}_{i} = 1 - max ( 𝒩 ( {P}_{i}^{R} log \frac{{P}_{i}^{R}}{{P}_{i}^{T}} ) , 𝒩 ( {P}_{i}^{T} log \frac{{P}_{i}^{T}}{{P}_{i}^{R}} ) ) \qquad Eq . ( 4 )$$

Here, {Pᵢ^{R}, Pᵢ^{T}} are the probabilistic segmentation predictions obtained in the C3L model 504. [symbol] (·) normalizes values to the range of 0 to 1, and max(·, ·) selects higher value from two KL directions. In one or more examples, to efficiently store reliable memory features with minimal memory usage, a denoised prototype-based memory bank 506 may be established. In one or more examples, for each memory feature fᵢ*, with * ∈{R, T}indicating the modality, C denoised class-level prototype features may be generated by spatially aggregating denoised features belonging to each category:

$${p}_{i}^{*} = 𝒢 ( {f}_{i}^{*} ⊗ {ℛ}_{i} , {Y}_{i}^{*} ) . \qquad Eq . ( 5 )$$

Here, ⊗ denotes the pixel-wise multiplication, and [symbol] is the aggregation operation. This results in an efficient and denoised memory bank {p*}_{*∈{R, T}}. Subsequently, our DMR model uses an attention mechanism to selectively retrieve relevant semantic information from the denoised memory bank, thereby refining features of the current frame. Taking RGB feature fᵢ^{R} as an example, the updated RGB feature Fᵢ^{R} is derived as follows:

$${w}^{*} = Softmax ( {\overline{f}}_{t}^{R} \times transpose ( {\overline{p}}^{*} ) ) , * ∈ \{ R , T \} \qquad Eq . ( 6 )$$

$${F}_{t}^{R} = ϕ ( [ {w}^{R} {p}^{R} , {w}^{T} {p}^{T} , {f}_{i}^{R} ] ) \qquad Eq . ( 7 )$$

Here, × denotes matrix multiplication, f̅ₜ^{R} and p̅* indicate L₂ normalized features, [·, ·, ·] means feature concatenation, and ϕ(·) is a convolutional operation to adjust channel size. In one or more examples, the DMR model 508 ultimately outputs two enhanced query features {Fₜ^{R}, Fₜ^{T}}, enriched with rich denoised temporal contexts from unlabeled past frames.

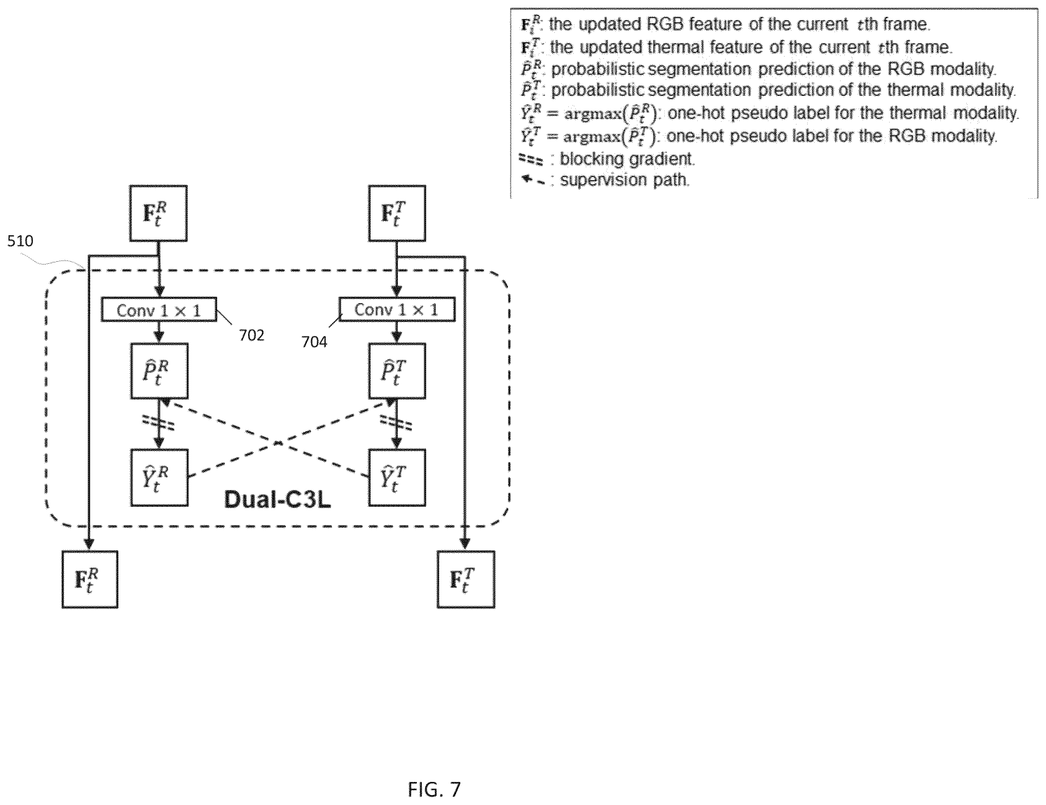

FIG. 7 illustrates an example structure of the Dual-C3L model 510. In one or more examples, enhanced query features {Fₜ^{R}, Fₜ^{T}} are provided to Conv 1×1 (702, 704). In order to make full use of the unlabeled data, and to further regularize the memory-updated features, a C3L loss on the updated features may be added and referred to as a Dual-C3L loss:

$${\hat{ℒ}}_{c 3 l} = {𝔼}_{( {I}_{t}^{R} , {I}_{t}^{T} ) ∈ {D}^{U} ⋃ {D}^{L}} ( {l}_{c e} ( {\hat{P}}_{t}^{R} , {\hat{Y}}_{t}^{T} ) + {l}_{c e} ( {\hat{P}}_{t}^{T} , {\hat{Y}}_{t}^{R} ) ) , \qquad Eq . ( 8 )$$

where {\hat{P}ₜ^{R}, \hat{P}ₜ^{T}} are updated predictions inferred from updated query features {Fₜ^{R}, Fₜ^{T}}, and {Ŷₜ^{R}, Ŷₜ^{T}} are corresponding pseudo labels.

Accordingly, for the labeled query pairs, an additional supervision loss may also be applied:

$${\hat{ℒ}}_{sup} = {𝔼}_{( {I}_{t}^{R} , {I}_{t}^{T} , y ) ∈ {𝒟}^{L}} ( {l}_{ce} ( {\hat{P}}_{t}^{R} , y ) + {l}_{ce} ( {\hat{P}}_{t}^{T} , y ) ) \qquad Eq . ( 9 )$$

To infer the final output, the updated query features {Fₜ^{R}, Fₜ^{T}} may be concatenated together, followed by a 3×3 convolutional layer as segmentation head to predict the final mask Pₜ^{final}. A supervised cross-entropy loss is also applied to Pₜ^{final}, as:

$${ℒ}_{sup}^{final} = {𝔼}_{( {I}_{t}^{R} , {I}_{t}^{T} , y ) ∈ {𝒟}^{L}} {l}_{ce} ( {P}_{t}^{final} , y ) \qquad Eq . ( 10 )$$

In one or more examples, the overall training objective may be defined as:

$${ℒ}_{total} = {ℒ}_{sup} + {\hat{ℒ}}_{sup} + {ℒ}_{sup}^{final} + λ ( {ℒ}_{c 3 l} + {\hat{ℒ}}_{c 3 l} ) , \qquad Eq . ( 11 )$$

where λ is the trade-off weight.

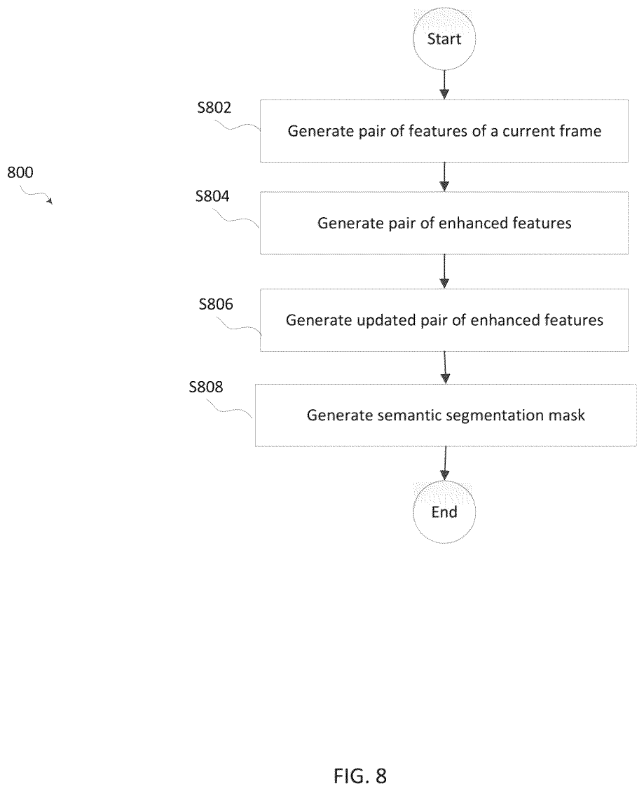

FIG. 8 illustrates a flow chart of an example process 800 for performing semi-supervised multispectral video semantic segmentation. In one or more examples, the process 800 may be performed by the processor 220 (FIG. 2).

The process proceeds to operation S802 where a pair of features are generated for a current frame. For example, feature pairs {fₜ^{R}, fₜ^{T}} may be obtained by inputting an RGB-Thermal pair of the current frame (unlabeled or labeled) are fed into a C3L model 502 (FIG. 5).

The process proceeds to operation S804 where a pair of enhanced features are generated. In or more examples, the pair of enhanced features may be denoised features. In one or more examples, RGB-thermal pairs (unlabeled) of prior frames may be input into C3L model 504 to obtain feature pairs {fᵢ^{R}, fᵢ^{T}}_{i∈{t-1, t-2, t-3}}. The feature pairs {fᵢ^{R}, fᵢ^{T}}_{i∈{t-1, t-2, t-3}} may be provided to memory bank 506, where the output of memory bank 506 and the output of the C3L model 502 are provided to the DMR model 508 to generate the pair of enhanced features {Fₜ^{R}, Fₜ^{T}}.

The process proceeds to operation S806 where an updated pair of enhanced features are generated. For example, the pair of enhanced features {Fₜ^{R}, Fₜ^{T}} are provided to the Dual-C3L model 510 (FIG. 10).

The process proceeds to operation S808 where a semantic segmentation mask is generated. For example, the output of the Dual-C3L model 510 is provided to the segmentation head 512 to obtain the semantic segmentation mask 514.

The embodiments have been described above and illustrated in terms of blocks, as shown in the drawings, which carry out the described function or functions. These blocks may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:

(1) A method performed by at least one processor, the method including: generating a pair of features of a current frame by inputting the current frame into a first cross-collaborative consistency learning (C3L) model, the current frame comprising a red-green-blue (RGB) image and a thermal image; generating a pair of denoised features by inputting the of pair of features of the current frame and one or more pairs of features of past frames into a denoised memory read (DMR) model; generating an updated pair of denoised features by inputting the pair of denoised features into a second C3L model, the updated pair of denoised features comprising an updated RGB image feature and an updated thermal feature; and generating a segmentation mask by inputting the updated pair of features into a segmentation head.

(2) The method according to feature (1), in which at least one of the RGB image and the thermal image is labeled.

(3) The method according to feature (1) or (2), in which the RGB image and the thermal image are not labeled.

(4) The method according to any one of features (1)-(3), in which the first C3L model includes a first semantic segmentation neural network that receives the RGB image and outputs an RGB feature of the pair of features, a second semantic segmentation neural network that receives the thermal image and outputs a thermal image feature of the pair of features, a first convolutional network that receives an output of the first semantic segmentation neural network and outputs a probabilistic segmentation prediction of a modality of the RGB image, and a second convolutional network that receives an output of the second semantic segmentation neural network and outputs a probabilistic segmentation prediction of a modality of the thermal image.

(5) The method according to feature (4), further including: determining a cross modality consistency between the RGB image and the thermal image based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

(6) The method according to any one of features (1)-(5), further including: generating the one or more pairs of features of the past frames by inputting the past frames into a third C3L model, each past frame comprising a past RGB image and a past thermal image; storing the one or more pairs of features in a denoised memory bank in accordance with a reliability condition; inputting the one or more pairs of features stored in the denoised memory bank into the DMR model; and in which each past frame is unlabeled.

(7) The method according to features (1)-(6), in which the second C3L model includes: a first convolutional network that receives the updated RGB image feature and outputs a probabilistic segmentation prediction of a modality of the RGB image, and a second convolutional network that receives the updated thermal image feature and outputs a probabilistic segmentation prediction of a modality of the thermal image.

(8) The method according to feature (7), further including: determining a cross modality consistency between the updated RGB image feature and the updated thermal image feature based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

(9) An apparatus including: a memory storing one or more instructions; and a processor operatively coupled to the memory and configured to execute the one or more instructions stored in the memory, in which the one or more instructions, when executed by the processor, cause the apparatus to: generate a pair of features of a current frame by inputting the current frame into a first cross-collaborative consistency learning (C3L) model, the current frame comprising a red-green-blue (RGB) image and a thermal image, generate a pair of denoised features by inputting the of pair of features of the current frame and one or more pairs of features of past frames into a denoised memory read (DMR) model, generate an updated pair of denoised features by inputting the pair of denoised features into a second C3L model, the updated pair of denoised features comprising an updated RGB image feature and an updated thermal feature, and generate a segmentation mask by inputting the updated pair of features into a segmentation head.

(10) The apparatus according to feature (9), in which at least one of the RGB image and the thermal image is labeled.

(11) The apparatus according to feature (9) or (10), in which the RGB image and the thermal image are not labeled.

(12) The apparatus according to any one of features (9)-(11), in which the first C3L model includes: a first semantic segmentation neural network that receives the RGB image and outputs an RGB feature of the pair of features, a second semantic segmentation neural network that receives the thermal image and outputs a thermal image feature of the pair of features, a first convolutional network that receives an output of the first semantic segmentation neural network and outputs a probabilistic segmentation prediction of a modality of the RGB image, and a second convolutional network that receives an output of the second semantic segmentation neural network and outputs a probabilistic segmentation prediction of a modality of the thermal image.

(13) The apparatus according to any one of features (9)-(12), in which the one or more instructions, when executed by the processor, cause the apparatus to: determine a cross modality consistency between the RGB image and the thermal image based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

(14) The apparatus according to any one of features (9)-(13), in which the one or more instructions, when executed by the processor, cause the apparatus to: generate the one or more pairs of features of the past frames by inputting the past frames into a third C3L model, each past frame comprising a past RGB image and a past thermal image, storing the one or more pairs of features in a denoised memory bank in accordance with a reliability condition, inputting the one or more pairs of features stored in the denoised memory bank into the DMR model, and in which each past frame is unlabeled.

(15) The apparatus according to any one of features (9)-(14), in which the second C3L model includes: a first convolutional network that receives the updated RGB image feature and outputs a probabilistic segmentation prediction of a modality of the RGB image, and a second convolutional network that receives the updated thermal image feature and outputs a probabilistic segmentation prediction of a modality of the thermal image.

(16) The apparatus according to any one of features (9)-(15), in which the one or more instructions, when executed by the processor, cause the apparatus to: determine a cross modality consistency between the updated RGB image feature and the updated thermal image feature based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

(17) A non-transitory computer readable medium having instructions stored therein, which when executed by a processor cause the processor to perform a method including: generating a pair of features of a current frame by inputting the current frame into a first cross-collaborative consistency learning (C3L) model, the current frame comprising a red-green-blue (RGB) image and a thermal image; generating a pair of denoised features by inputting the of pair of features of the current frame and one or more pairs of features of past frames into a denoised memory read (DMR) model; generating an updated pair of denoised features by inputting the pair of denoised features into a second C3L model, the updated pair of denoised features comprising an updated RGB image feature and an updated thermal feature; and generating a segmentation mask by inputting the updated pair of features into a segmentation head.

(18) The non-transitory computer readable medium according to feature (17), in which at least one of the RGB image and the thermal image is labeled.

(19) The non-transitory computer readable medium according to feature (17) and (18), in which the RGB image and the thermal image are not labeled.

(20) The non-transitory computer readable medium according to feature 17, in which the first C3L model includes: a first semantic segmentation neural network that receives the RGB image and outputs an RGB feature of the pair of features, a second semantic segmentation neural network that receives the thermal image and outputs a thermal image feature of the pair of features, a first convolutional network that receives an output of the first semantic segmentation neural network and outputs a probabilistic segmentation prediction of a modality of the RGB image, and a second convolutional network that receives an output of the second semantic segmentation neural network and outputs a probabilistic segmentation prediction of a modality of the thermal image.

What is claimed is:

1. A method performed by at least one processor, the method comprising:
generating a pair of features of a current frame by inputting the current frame into a first cross-collaborative consistency learning (C3L) model, the current frame comprising a red-green-blue (RGB) image and a thermal image;
generating a pair of denoised features by inputting the of pair of features of the current frame and one or more pairs of features of past frames into a denoised memory read (DMR) model;
generating an updated pair of denoised features by inputting the pair of denoised features into a second C3L model, the updated pair of denoised features comprising an updated RGB image feature and an updated thermal feature; and
generating a segmentation mask by inputting the updated pair of features into a segmentation head.

2. The method according to claim 1, wherein at least one of the RGB image and the thermal image is labeled.

3. The method according to claim 1, wherein the RGB image and the thermal image are not labeled.

4. The method according to claim 1, wherein the first C3L model comprises
a first semantic segmentation neural network that receives the RGB image and outputs an RGB feature of the pair of features,
a second semantic segmentation neural network that receives the thermal image and outputs a thermal image feature of the pair of features,
a first convolutional network that receives an output of the first semantic segmentation neural network and outputs a probabilistic segmentation prediction of a modality of the RGB image, and
a second convolutional network that receives an output of the second semantic segmentation neural network and outputs a probabilistic segmentation prediction of a modality of the thermal image.

5. The method according to claim 4, further comprising:
determining a cross modality consistency between the RGB image and the thermal image based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

6. The method according to claim 1, further comprising:
generating the one or more pairs of features of the past frames by inputting the past frames into a third C3L model, each past frame comprising a past RGB image and a past thermal image;
storing the one or more pairs of features in a denoised memory bank in accordance with a reliability condition;
inputting the one or more pairs of features stored in the denoised memory bank into the DMR model; and
wherein each past frame is unlabeled.

7. The method according to claim 1, wherein the second C3L model comprises:
a first convolutional network that receives the updated RGB image feature and outputs a probabilistic segmentation prediction of a modality of the RGB image, and
a second convolutional network that receives the updated thermal image feature and outputs a probabilistic segmentation prediction of a modality of the thermal image.

8. The method according to claim 7, further comprising:
determining a cross modality consistency between the updated RGB image feature and the updated thermal image feature based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

9. An apparatus comprising:
a memory storing one or more instructions; and
a processor operatively coupled to the memory and configured to execute the one or more instructions stored in the memory,
wherein the one or more instructions, when executed by the processor, cause the apparatus to:
generate a pair of features of a current frame by inputting the current frame into a first cross-collaborative consistency learning (C3L) model, the current frame comprising a red-green-blue (RGB) image and a thermal image,
generate a pair of denoised features by inputting the of pair of features of the current frame and one or more pairs of features of past frames into a denoised memory read (DMR) model,
generate an updated pair of denoised features by inputting the pair of denoised features into a second C3L model, the updated pair of denoised features comprising an updated RGB image feature and an updated thermal feature, and
generate a segmentation mask by inputting the updated pair of features into a segmentation head.

10. The apparatus according to claim 9, wherein at least one of the RGB image and the thermal image is labeled.

11. The apparatus according to claim 9, wherein the RGB image and the thermal image are not labeled.

12. The apparatus according to claim 9, wherein the first C3L model comprises:
a first semantic segmentation neural network that receives the RGB image and outputs an RGB feature of the pair of features,
a second semantic segmentation neural network that receives the thermal image and outputs a thermal image feature of the pair of features,
a first convolutional network that receives an output of the first semantic segmentation neural network and outputs a probabilistic segmentation prediction of a modality of the RGB image, and
a second convolutional network that receives an output of the second semantic segmentation neural network and outputs a probabilistic segmentation prediction of a modality of the thermal image.

13. The apparatus according to claim 9, wherein the one or more instructions, when executed by the processor, cause the apparatus to:
determine a cross modality consistency between the RGB image and the thermal image based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

14. The apparatus according to claim 9, wherein the one or more instructions, when executed by the processor, cause the apparatus to:
generate the one or more pairs of features of the past frames by inputting the past frames into a third C3L model, each past frame comprising a past RGB image and a past thermal image,
storing the one or more pairs of features in a denoised memory bank in accordance with a reliability condition,
inputting the one or more pairs of features stored in the denoised memory bank into the DMR model, and
wherein each past frame is unlabeled.

15. The apparatus according to claim 9, wherein the second C3L model comprises:
a first convolutional network that receives the updated RGB image feature and outputs a probabilistic segmentation prediction of a modality of the RGB image, and
a second convolutional network that receives the updated thermal image feature and outputs a probabilistic segmentation prediction of a modality of the thermal image.

16. The apparatus according to claim 9, wherein the one or more instructions, when executed by the processor, cause the apparatus to:
determine a cross modality consistency between the updated RGB image feature and the updated thermal image feature based on a loss function that uses the probabilistic segmentation prediction of the modality of the RGB image, the probabilistic segmentation prediction of the modality of the thermal image, a pseudo label for the modality of the RGB image, and a pseudo label for the modality of the thermal image.

17. A non-transitory computer readable medium having instructions stored therein, which when executed by a processor cause the processor to perform a method comprising:
generating a pair of features of a current frame by inputting the current frame into a first cross-collaborative consistency learning (C3L) model, the current frame comprising a red-green-blue (RGB) image and a thermal image;
generating a pair of denoised features by inputting the of pair of features of the current frame and one or more pairs of features of past frames into a denoised memory read (DMR) model;
generating an updated pair of denoised features by inputting the pair of denoised features into a second C3L model, the updated pair of denoised features comprising an updated RGB image feature and an updated thermal feature; and
generating a segmentation mask by inputting the updated pair of features into a segmentation head.

18. The non-transitory computer readable medium according to claim 17, wherein at least one of the RGB image and the thermal image is labeled.

19. The non-transitory computer readable medium according to claim 17, wherein the RGB image and the thermal image are not labeled.

20. The non-transitory computer readable medium according to claim 17, wherein the first C3L model comprises:
a first semantic segmentation neural network that receives the RGB image and outputs an RGB feature of the pair of features,
a second semantic segmentation neural network that receives the thermal image and outputs a thermal image feature of the pair of features,
a first convolutional network that receives an output of the first semantic segmentation neural network and outputs a probabilistic segmentation prediction of a modality of the RGB image, and
a second convolutional network that receives an output of the second semantic segmentation neural network and outputs a probabilistic segmentation prediction of a modality of the thermal image.
